(19) United States
(12) Patent Application Publication
(10) Pub. No.: US 2004/0192393 A1
(43) Pub. Date: Sep. 30, 2004

(54) Antenna control unit

(75) Inventors: Nobuhiko Ishihara, Kawasaki (JP); Atsushi Yamashita, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/353,008

(22) Filed: Jan. 29, 2003

(30) Foreign Application Priority Data
Aug. 9, 2002 (JP) 2002-232590

(51) Int. Cl. H04M 1/00

(52) U.S. Cl. 455/562.1; 455/561

(57) ABSTRACT

An antenna control unit that is applicable to a cellular communications system that employs sectorized cells, each cell consisting of a plurality of sectors, adjusts the beam width of a directional antenna that is provided to each sector such that downlink transmission power levels of the sectors are made equal.

### BACKGROUND OF THE INVENTION

1. Field of the Invention

The present invention generally relates to a cellular communications system that uses sectorized cells, and especially relates to an antenna control unit in the cellular communications system.

2. Description of the Related Art

The cellular communications system includes mobile terminals, base stations each of which is located in a cell that is a geographical area constituting a service area, and a network side element that controls the base stations.

Generally, the cell is divided into two or more sectors in order to accommodate as many subscribers as possible in the cell. Providing sectors in the cell raises the accommodation capacity of the cell, because directivity of a directional antenna prepared for each sector is adjusted such that interference between the sectors is suppressed. In addition, voice activation technology can be used in order to increase the number of the subscribers that can be accommodated in the cell, using the fact that a silent period is typically longer than a voiced period in conventional voice communications.

Since the mobile terminal accommodated in the cell moves, not only the distance between the mobile terminal and the base station changes, but also the sector (or cell) to which the mobile terminal belongs may change. For this reason, the number of mobile terminals (the number of subscribers) often becomes uneven between sectors.

FIG. 1 shows an example where the number of subscribers is different from cell to cell. In FIG. 1, the cell is divided into three sectors A, B, and C, with eight mobile terminals present in sector A, and three mobile terminals present in each of the sectors B and C, as illustrated. Here, the maximum number of calls that can be simultaneously connected per sector is set at 5, for example. Then, three mobile terminals out of the eight that are present in sector A will not be able to be connected, the three mobile terminals being indicated by X1, X2, and X3 with a white circle, while the five others, indicated by black circles, are successfully communicating. On the other hand, each of the sectors B and C is serving only three terminals presently, being capable of serving additional mobile terminals.

Incidentally, there is a function of controlling transmission power (transmission power control) in a code division multiple access (CDMA) cellular communications system. The function controls the electric transmission power of the mobile terminal such that the base station receives a signal from the mobile terminal at a quality level equal to or better than a predetermined level (e.g., received field strength, a signal to noise ratio, and the like). That is, a mobile terminal located near the base station is controlled to transmit at comparatively low power, and another mobile terminal that is located far from the base station is controlled to transmit at comparatively high power. Using the automatic power control function, the accommodation capacity of the cell can be increased, by determining the number of mobile terminals in the sector, and controlling such that the number of mobile terminals in each sector becomes equal or approximately equal.

FIG. 2 shows the cell after an adjustment is made such that each sector serves an approximately equal number of mobile terminals. The mobile terminals Y1 and Y2 that previously belonged to sector A now belong to sector C, as illustrated in FIG. 2. Similarly, the mobile terminal Z that previously belonged to sector A now belongs to sector B. Consequently, each of the sectors A and B now serves five mobile terminals, and sector C serves four mobile terminals. In this manner, the sectorized cell configuration is advantageous over a non-sectorized cell, being capable of serving more subscribers.

Recently, service contents of the cellular communications systems have been diversified. That is, the systems are required to provide not only a plurality of transmission speeds for voice communications (for example, 9.6 kbps and 12.2 kbps), but also variety of transmission speeds for data communications (for example, 14.4 kbps and 2 Mbps). Moreover, various quality levels of signals are required. That is, the mobile terminals in a cell present not only geographical unevenness, but require different service contents at different quality levels. This tendency will become even stronger with continued diversification of the service contents.

Under a situation such as described above, building sectors such that the number of mobile terminals belonging to each sector become equal does not necessarily enhance the accommodation capacity of the cell. For example, if a mobile terminal requires a data distribution service for a large volume content at a high speed, a large amount of downlink transmission power is necessary. The amount of the downlink transmission power becomes even greater if the mobile terminal is located far from the base station. Consequently, adjusting the number of mobile terminals to be the same in each sector does not provide a satisfactory solution.

Although JP,2000-165319, A indicates the technology that controls the directivity of a sector (antenna) according to a communication situation with mobile stations, such as the number of mobile stations of each sector, a ratio of received signal power to interference power (SIR), and a received signal error rate, it does not solve the above-mentioned problem of uneven distribution of traffic in a downlink circuit (downlink channel), and the like. According to the conventional technique, it is difficult to flexibly raise the accommodation capacity of a cell in response to the uneven distribution of traffic, especially in the downlink channel.

### SUMMARY OF THE INVENTION

Accordingly, the general object of the present invention is to provide an antenna control unit of a cellular communications system that: flexibly responds to unevenness of communication situations such as geographical unevenness of mobile terminal locations and traffic unevenness in downlink channels; raises accommodation capacity of the cell; and substantially obviates one or more of the problems caused by the limitations and disadvantages of the related art.

The specific object of the present invention is to provide an antenna control unit that controls beam width of a directional antenna such that downlink transmission power becomes equal from sector to sector of the cell.

Features and advantages of the present invention will be set forth in the description that follows, and in part will become apparent from the description and the accompanying drawings, or may be learned by practice of the invention according to the teachings provided in the description. Objects as well as other features and advantages of the present invention will be realized and attained by the antenna control unit particularly pointed out in the specification in such full, clear, concise, and exact terms as to enable a person having ordinary skill in the art to practice the invention.

To achieve these and other advantages and in accordance with the purpose of the invention, as embodied and broadly described herein, the present invention provides an antenna control unit that controls the beam width of the directional antenna of each sector such that downlink transmission power relative to at least two sectors becomes the same, or approximately the same, for each of the sectors.

FIG. 3 and FIG. 4 are conceptual diagrams for explaining the principle of the present invention. Here, a cell is configured by three sectors A, B, and C (3-sector cell), like FIG. 1 and FIG. 2, each sector being served by an antenna dedicated to that sector. Although the number of the sectors is set at 3 for explanation purposes, the number can be greater. Thickness of the arrows in the drawings indicates magnitude of the downlink transmission power to each sector (specifically, to mobile terminals in each sector).

FIG. 3 shows a state wherein the transmission power level of sector A is higher than the transmission power level of sectors B and C. This state occurs when, for example, a mobile terminal being served by sector A downloads a large volume content at a high speed. In this case, the antenna control unit (not shown in FIG. 3) of the present invention determines that no more subscribers can be accommodated in the sector A, while looking at the transmission power levels for each of the sectors A, B, and C. Then, the antenna control unit adjusts beam width of each of the antennas such that the transmission power levels for the sectors become equal to each other. In the present example, the beam width of the antenna of the sector A is reduced, and the beam width of the antenna for each of the sectors B and C is expanded.

FIG. 4 shows a state wherein the antenna beam width adjustment has been carried out as described above, with the power levels to all the sectors having become equal. Consequently, even when downlink traffic is uneven over the sectors, the sectors are reconfigured based on the downlink transmission power level, such that the number of subscribers that the cell can accommodate is maximized.

### BRIEF DESCRIPTION OF THE DRAWINGS

FIG. 1 is a conceptual diagram showing a distribution of mobile terminals in a 3-sector cell;

FIG. 2 is a conceptual diagram showing a distribution of the mobile terminals in the 3-sector cell;

FIG. 3 is a conceptual diagram for explaining the principle of the present invention;

FIG. 4 is a conceptual diagram for explaining the principle of the present invention;

FIG. 5 is a block diagram showing an outline of a cellular radio base station that includes an antenna control unit of the embodiment of the present invention;

FIG. 6 is a flowchart showing a method to control an antenna according to the first embodiment of the present invention;

FIG. 7 is a flowchart (part 1) showing a method to control the antenna according to the second embodiment of the present invention;

FIG. 8 is a flowchart (part 2) showing the method to control the antenna according to the second embodiment of the present invention;

FIG. 9 is a flowchart (part 3) showing the method to control the antenna according to the second embodiment of the present invention;

FIG. 10 is a flowchart showing a method to control the antenna according to the third embodiment of the present invention; and

FIG. 11 is a flowchart showing a method to control the antenna according to the fourth embodiment of the present invention.

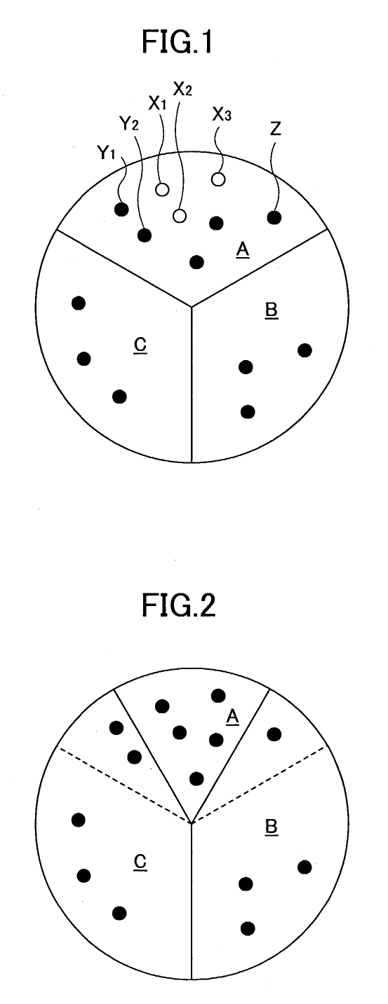

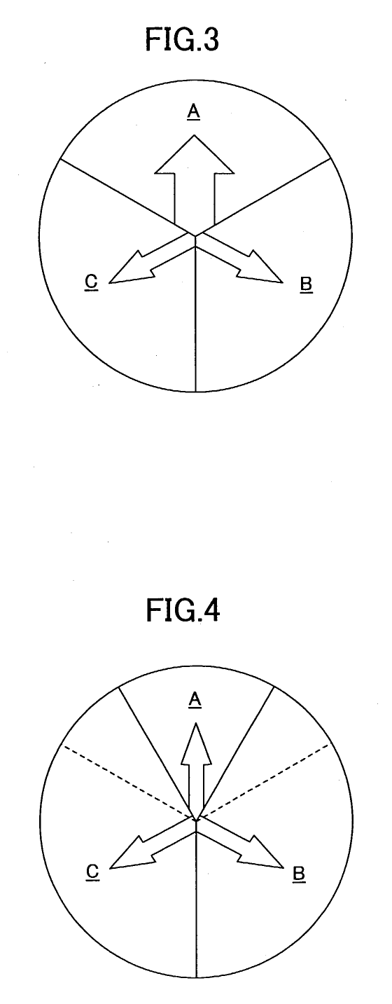

### DESCRIPTION OF THE PREFERRED EMBODIMENTS

In the following, embodiments of the present invention will be described with reference to the accompanying drawings.

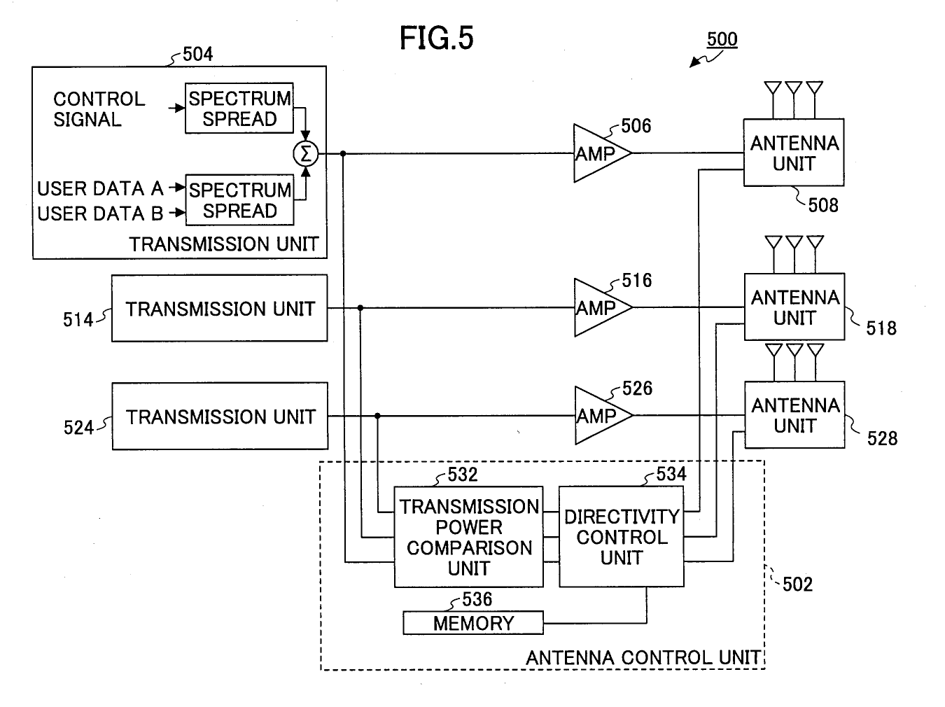

FIG. 5 is a block diagram showing an outline of a cellular radio base station 500 that includes an antenna control unit 502 of the embodiment of the present invention. For explanation purposes, a 3-sector cell, consisting of sectors A, B, and C, will be described, however, the cell can be formed by more than 3 sectors.

The base station 500 includes a transmitting unit 504, an amplifier unit 506 that amplifies an RF signal from the transmitting unit 504, and a beam width variable antenna unit 508 that emits the RF signal amplified by the amplifier unit 506, relative to the section A. The beam width variable antenna (a directional antenna) is capable of changing beam width by using an array antenna and changing weights of each antenna element. The RF signal from the transmitting unit 504 contains data signals addressed to a plurality of mobile terminals (not shown), the data signals being code-multiplexed by unique diffusion codes. The RF signal is transmitted from the antenna unit 508 to the mobile terminals that mainly belong to the sector A. Similarly, relative to the sector B, the base station 500 includes a transmitting unit 514, an amplifier unit 516, and a beam width variable antenna unit 518. Further, the base station 500 includes a transmitting unit 524, an amplifier unit 526, and a beam width variable antenna unit 528, relative to the sector C.

Furthermore, the base station 500 includes an antenna control unit 502, which further includes a transmission power comparison unit 532, a directivity control unit 534, and a storage unit 536. Connections are made as follows such that the transmission signal (downlink signal) to each of the sectors, A, B, and C, is properly supervised. The directivity control unit 534 of the antenna control unit 502 is connected to the antenna units 508, 518, and 528, such that a control signal is provided to the antenna units 508, 518, and 528, relative to the sectors A, B, and C, respectively. The transmission power comparison unit 532 of the antenna control unit 502 is connected to the transmitting units 504, 514, and 524, such that the signal levels of RF signals from the transmitting units 504, 514, and 524 are compared with each other. The storage unit 536 stores various kinds of parameters relative to directivity control of the antenna units.

Sets of user data to a plurality of mobile terminals are added together, after each of the sets of the user data is diffusion-modulated by a diffusion code that is unique to each user. Further, a control signal that is generated separately is added, and is input into corresponding amplifier units 506, 516, and 526.

While the transmission signal from each of the transmitting units 504, 514, and 524 is input into the corresponding amplifier unit, the signals are also input into the transmission power comparison unit 532, and the signal levels are measured, and then compared with each other. Through this comparison operation, unevenness of the transmission power levels can be supervised. The transmission power comparison unit 532 and the directivity control unit 534 direct each of the antenna units 508, 518, and 528 such that the beam of the corresponding antenna is reconfigured such that the transmission power levels of the sectors become equal to each other.

Although the example shown in FIG. 5 provides the antenna control unit 502 in the base station 500, the antenna control unit 502 may be provided in a base station control unit (not shown) that controls a base station, or on a higher order network side.

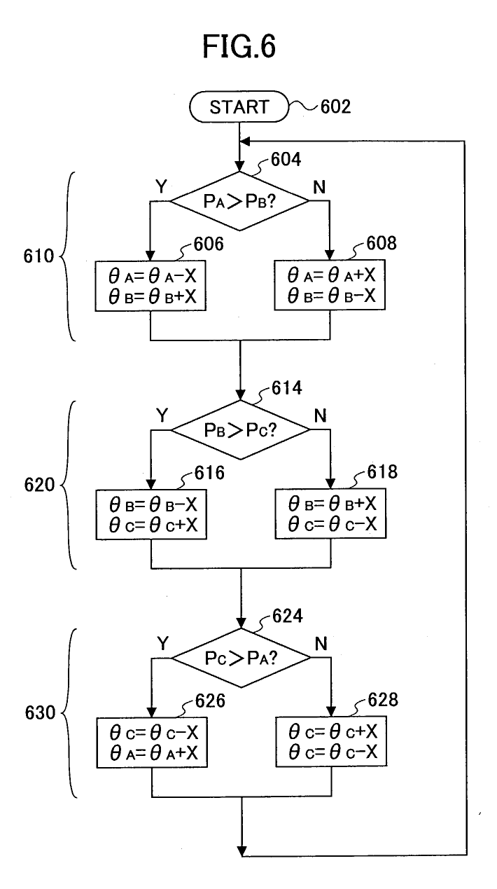

FIG. 6 is a flowchart showing a method to control the antenna of the first embodiment of the present invention. The embodiment is described using a 3-sector cell, having three sectors A, B, and C, for explanation purposes, however, the cell can be divided into more than 3 sectors.

The method of the first embodiment starts at Step 602. At Step 604, it is determined whether the downlink transmission power level P_{A} of the sector A is greater than the downlink transmission power level P_{B} of the sector B. If it is determined that the transmission power level P_{A} is greater than the transmission power level P_{B}, the process progresses to Step 606. At Step 606, the beam width θ_{A} of the antenna of the sector A is reduced by a predetermined amount X, and the beam width θ_{B} of the antenna of the sector B is expanded by the predetermined amount X. Consequently, the transmission power level of the sector A is decreased, and the transmission power level of the sector B is increased. As described above, the transmission power comparison unit 532 of the antenna control unit 502 (FIG. 5) measures and compares the transmission power levels. To the contrary, if, at Step 604, it is determined that the transmission power level P_{A} is not greater than the transmission power level P_{B}, the process progresses to Step 608. At Step 608, conversely to Step 606, the beam width θ_{A} of the antenna of the sector A is expanded by the predetermined amount X, and the beam width θ_{B} of the antenna of the sector B is reduced by the predetermined amount X. In this manner, Step 610 of the comparison of the downlink transmission power and the beam width adjustment relative to the sectors A and B is performed.

The downlink transmission power levels P_{B} and P_{C} of the sectors B and C, respectively, are compared at Step 614, following Step 610. If it is determined that the transmission power level P_{B} is greater than the transmission power level P_{C}, the process progresses to Step 616, where the beam width θ_{B} of the antenna of the sector B is reduced by the predetermined amount X, and the beam width θ_{C} of the antenna of the sector C is increased by the predetermined amount X. If it is determined that the transmission power level P_{B} is not greater than the transmission power level P_{C}, the process progresses to Step 618, where the beam width θ_{B} of the antenna of the sector B is increased by the predetermined amount X, and the beam width θ_{C} of the antenna of the sector C is reduced by the predetermined amount. In this manner, Step 620 of the comparison and beam width adjustment of the downlink transmission power relative to the sectors B and C is performed.

Furthermore, the downlink transmission power levels P_{C} and P_{A} of the sectors C and A, respectively, are compared at Step 624, following Step 616 and Step 618. If it is determined that the transmission power level P_{C} is greater than the transmission power level P_{A}, the process progresses to Step 626, where the beam width θ_{C} of the antenna of the sector C is reduced by the predetermined amount X, and the beam width θ_{A} of the antenna of the sector A is increased by the predetermined amount X. If it is determined that the transmission power level P_{C} is not greater than the transmission power level P_{A}, the process progresses to Step 628, where the beam width θ_{C} of the antenna of the sector C is increased, and the beam width θ_{A} of the antenna of the sector A is reduced. In this manner, Step 630 of the comparison and beam width adjustment of the downlink transmission power levels of the sectors C and A is performed. Henceforth, the process returns to Step 604, followed by Step 610 relative to the sectors A and B, Step 620 relative to the sectors B and C, and Step 630 relative to the sectors C and A, until the beam widths of the antennas are satisfactorily converged.

Generally, the greater the predetermined amount X is, the quicker the convergence of the beam widths of the antennas can be obtained, at the sacrifice of the stability of the system. Conversely, the smaller the predetermined amount X is, the more stable will be the system operation, at the sacrifice of the time required for the convergence. The predetermined amount X is defined experientially, and is stored in the storage unit 536 (FIG. 5). The magnitude of the predetermined amount X depends on a geographical location such as a city section and urban area, a time zone like day and night, and various other factors such as voice service or data service, data speed, and others.

The time required for convergence can be adjusted by changing the predetermined amount X according to a convergence state. For this purpose, the number of beam width expanding operations and the number of beam width reducing operations within a predetermined period are counted and stored in the storage unit 536 (FIG. 5). If the number of the beam width expanding operations is greatly different from the number of the beam width reducing operations, indicating that the beam width is greatly changing, the value of the predetermined amount X is enlarged. Conversely, if the numbers are more or less equal to each other, the value of the predetermined amount X may be set smaller. Furthermore, it is also possible to enlarge the predetermined amount X when a transmission power level for a sector is greatly different from a transmission power level for another sector, as measured by the transmission power comparison unit 532 (FIG. 5). Conversely, if the transmission power levels are almost the same, the predetermined amount X can be set smaller. The beam width adjustment as above can be performed when an absolute value of the difference of the transmission power levels exceeds a predetermined threshold.

According to the present embodiment, the beam width of the directional antenna of each sector is adjusted according to the difference of the downlink transmission power levels of two adjoining sectors. In this manner, this method provides an even distribution of the downlink transmission power levels over the sectors, and adjusts the beam width of the directional antenna of each sector by simply comparing the downlink transmission power levels, eliminating complicated calculations.

According to the present embodiment, every time the downlink transmission power of a sector is compared with the downlink transmission power of an adjacent sector, sequentially one by one, the beam width of the corresponding directional antenna is adjusted by a predetermined amount. The predetermined amount is variable, and adjusted adequately so that the convergence of the beam width is performed quickly, and the downlink transmission power levels are made even among the sectors.

According to the present embodiment, which provides the storage unit to record the number of beam width expansion operations and the number of beam width reduction operations, an adjustment of the value of the predetermined amount X is realized based on the numbers of the operations.

According to the present embodiment, the value of the predetermined amount is changed based on the amount of differences of the downlink transmission power levels over the sectors, such that a more suitable predetermined amount is attained.

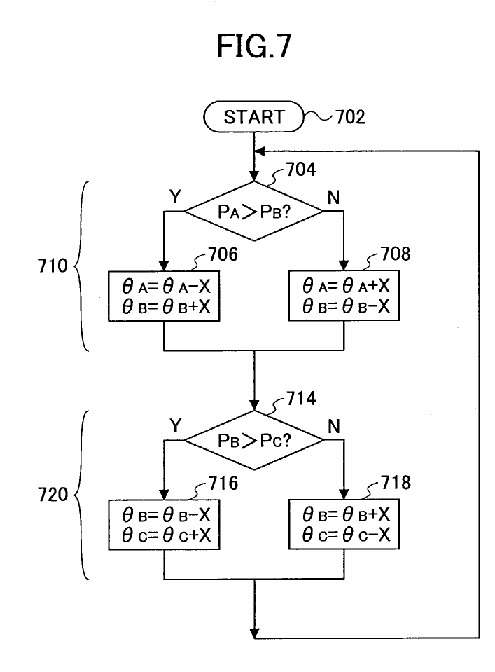

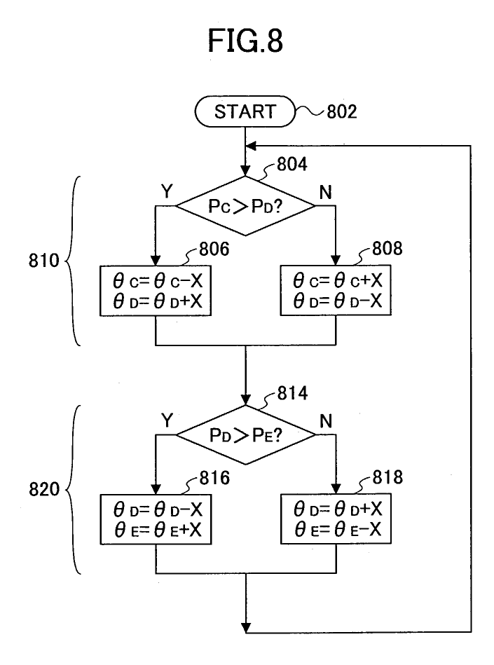

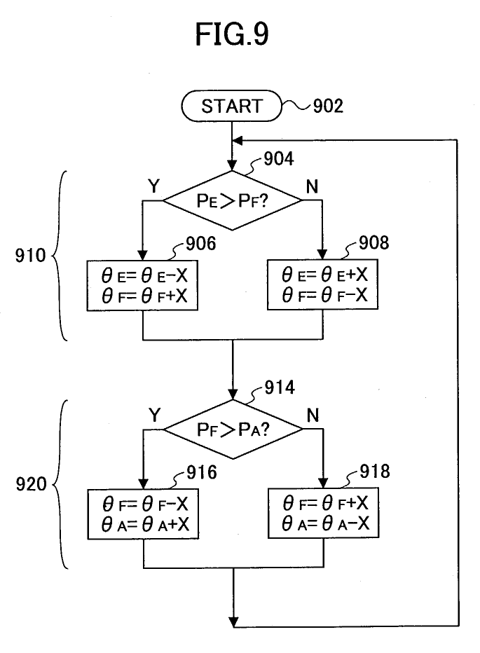

The second embodiment of the antenna beam control method of the present invention is explained, using FIG. 7, FIG. 8 and FIG. 9 that are flowcharts (part 1), (part 2), and (part 3), respectively. In the second embodiment, a cell is divided into six sectors A, B, C, D, E, and F, for explanation convenience, however, the number of the cells can be greater.

The method shown in FIG. 7 begins at Step 702. At Step 704, it is determined whether the downlink transmission power level P_{A} of the sector A is greater than the downlink transmission power level P_{B} of the sector B. If it is determined that the transmission power level P_{A} is greater than the transmission power level P_{B}, the process progresses to Step 706. At Step 706, the beam width θ_{A} of the antenna of the sector A is reduced by a predetermined amount X, and the beam width θ_{B} of the antenna of the sector B is expanded by the predetermined amount X. Consequently, the downlink transmission power of the sector A is decreased, while the downlink transmission power of the sector B is increased. On the other hand, in Step 704, if it is determined that the transmission power level P_{A} is not greater than the transmission power level P_{B}, the process progresses to Step 708. At Step 708, conversely to Step 706, the beam width θ_{A} of the antenna of the sector A is expanded by the predetermined amount X, and the beam width θ_{B} of the antenna of the sector B is reduced by the same amount. In this manner, Step 710 of comparison of the downlink transmission power and beam adjustment relative to the sector A and the sector B is performed.

At Step 714 following Step 710, the downlink transmission power levels P_{B} and P_{C} relative to the sectors B and C are compared with each other. If the transmission power level P_{B} is greater than the transmission power level P_{C}, the process progresses to Step 716, where the beam width θ_{B} of the antenna of the sector B is reduced by the predetermined amount X, and the beam width θ_{C} of the antenna of the sector C is expanded by the same amount. If the transmission power level P_{B} is not greater than the transmission power level P_{C}, the process progresses to Step 718, where the beam width θ_{B} of the antenna of the sector B is expanded, and the beam width θ_{C} of the antenna of the sector C is reduced. In this manner, Step 720 of the comparison of the downlink transmission power and beam adjustment relative to the sector B and the sector C is performed.

Similarly, Step 810 of the comparison of the downlink transmission power and beam adjustment relative to Sectors C and D, and Step 820 of the comparison of the downlink transmission power and beam adjustment relative to Sectors D and E are performed as shown in FIG. 8.

At Step 804, it is determined whether the downlink transmission power level P_{C} of the sector C is greater than the downlink transmission power level P_{D} of the sector D. If it is determined that the transmission power level P_{C} is greater than the transmission power level P_{D}, the process progresses to Step 806. At Step 806, the beam width θ_{C} of the antenna of the sector C is reduced by a predetermined amount X, and the beam width θ_{D} of the antenna of the sector D is expanded by the predetermined amount X. On the other hand, in Step 804, if it is determined that the transmission power level P_{C} is not greater than the transmission power level P_{D}, the process progresses to Step 808. At Step 808, conversely to Step 806, the beam width θ_{C} of the antenna of the sector C is expanded by the predetermined amount X, and the beam width θ_{D} of the antenna of the sector D is reduced by the same amount. In this manner, Step 810 of comparison of the downlink transmission power and beam adjustment relative to the sector C and the sector D is performed.

Following Step 810, the downlink transmission power levels P_{D} and P_{E} relative to the sectors D and E are compared with each other at Step 814. If the transmission power level P_{D} is greater than the transmission power level P_{E}, the process progresses to Step 816, where the beam width θ_{D} of the antenna of the sector D is reduced by the predetermined amount X, and the beam width θ_{E} of the antenna of the sector E is expanded by the same amount. If the transmission power level P_{D} is not greater than the transmission power level P_{E}, the process progresses to Step 818, where the beam width θ_{D} of the antenna of the sector D is expanded, and the beam width θ_{E} of the antenna of the sector E is reduced. In this manner, Step 820 of the comparison of the downlink transmission power and beam adjustment relative to the sector D and the sector E is performed.

Similarly, Step 910 of the comparison of the downlink transmission power and beam adjustment relative to Sectors E and F, and Step 920 of the comparison of the downlink transmission power and beam adjustment relative to Sectors F and A are performed as shown in FIG. 9.

At Step 904, it is determined whether the downlink transmission power level P_{E} of the sector E is greater than the downlink transmission power level P_{F} of the sector F. If it is determined that the transmission power level P_{E} is greater than the transmission power level P_{F}, the process progresses to Step 906. At Step 906, the beam width θ_{E} of the antenna of the sector E is reduced by a predetermined amount X, and the beam width θ_{F} of the antenna of the sector F is expanded by the predetermined amount X. On the other hand, in Step 904, if it is determined that the transmission power level P_{E} is not greater than the transmission power level P_{F}, the process progresses to Step 908. At Step 908, conversely to Step 906, the beam width θ_{E} of the antenna of the sector E is expanded by the predetermined amount X, and the beam width θ_{F} of the antenna of the sector F is reduced by the same amount. In this manner, Step 910 of comparison of the downlink transmission power and beam adjustment relative to the sector E and the sector F is performed.

Following Step 910, the downlink transmission power levels P_{F} and P_{A} relative to the sectors F and A are compared at Step 914. If the transmission power level P_{F} is greater than transmission power level P_{A}, the process progresses to Step 916, where the beam width θ_{F} of the antenna of the sector F is reduced by the predetermined amount X, and the beam width θ_{A} of the antenna of the sector A is expanded by the same amount. If the transmission power level P_{F} is not greater than the transmission power level P_{A}, the process progresses to Step 918, where the beam width θ_{F} of the antenna of the sector F is expanded, and the beam width θ_{A} of the antenna of the sector A is reduced. In this manner, Step 920 of the comparison of the downlink transmission power and beam adjustment relative to the sector F and the sector A is performed.

Here, attention is drawn to the fact that the flows explained in FIG. 7, FIG. 8, and FIG. 9 are performed in parallel. For example, Step 710 of the power comparison and beam adjustment relative to the sectors A and B of FIG. 7, Step 810 of the power comparison and beam adjustment relative to the sectors C and D of FIG. 8, and Step 910 of the power comparison and beam adjustment relative to the sectors E and F of FIG. 9 can be carried out simultaneously. Similarly, Step 720 of FIG. 7, Step 820 of FIG. 8, and Step 920 of FIG. 9 can also be carried out simultaneously. The second embodiment that involves more sectors than the first embodiment can perform beam adjustment more quickly than the first embodiment (FIG. 6) that performs Step 610, 620, and 630 of the power comparison and beam adjustment sequentially in the order of A-B, B-C, and C-A relative to the three sectors A, B, and C.

According to the second embodiment, the beam width of the directional antenna of each sector is adjusted based on the comparison of the download transmission power levels of the two adjoining sectors. In this manner of the simple comparison, equalization of the transmission power over the sectors is attained, and the beam widths of the directional antennas of the sectors are adjusted simply, without performing complicated calculations.

As described above, according to the second embodiment, as for certain sectors, e.g., B, D, and F, first, the downlink transmission power levels are compared with sectors that are adjacent in one direction, e.g., A, C, and E, respectively, and the beam width of each antenna is adjusted in one operation; and then, the downlink transmission power levels of the sectors B, D, and F, are compared with the downlink transmission power levels of the sectors that are adjacent in the other direction, e.g., C, E and A, respectively, and the beam width of each antenna is adjusted in another operation. In this manner, a plurality of pairs of the sectors are simultaneously compared, with the beam width adjustment following. Accordingly, the downlink transmission power level can quickly respond to environmental changes, and equal transmission power levels over the sectors can be attained quickly.

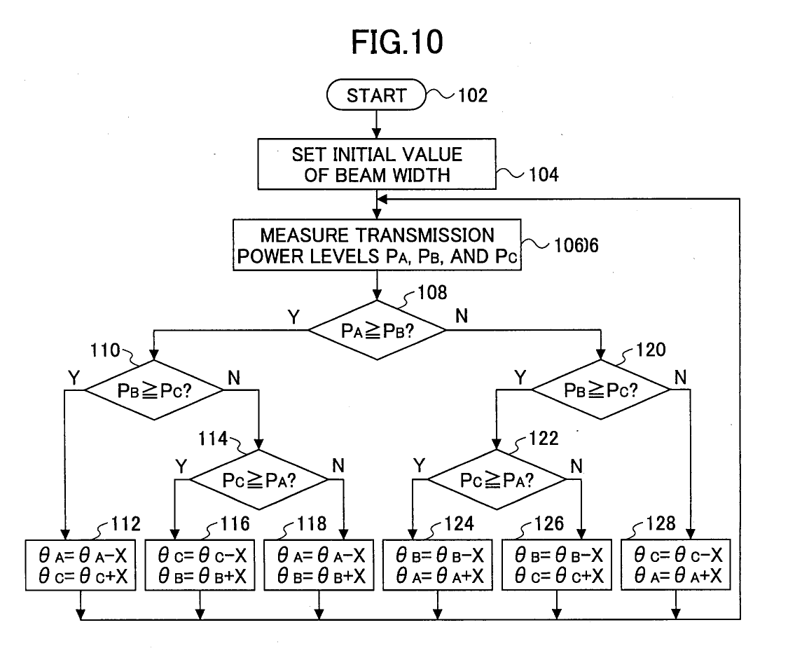

FIG. 10 is a flowchart that shows the third embodiment of the beam width controlling method. For explanation purposes, a 3-sector cell, consisting of the sectors A, B, and C, is described. However, the cell can be structured with more than three sectors.

The method of the third embodiment starts at Step 102. At Step 104, an initial value of the beam width (transmission power value) of each sector is set up. Although the initial value can be set up such that the beam width of each sector is the same, different values may be assigned from sector to sector, where deviation of traffic, subscribers and the like can be predicted to some extent.

At Step 106, the downlink transmission power levels P_{A}, P_{B}, and P_{C} of the sectors A, B, and C, respectively, are measured for future comparison processes. The transmission power comparison unit 532 of the antenna control unit 502 (FIG. 5) measures and compares the transmission power levels.

At Step 108, the downlink transmission power levels P_{A} and P_{B} of the sectors A and B, respectively, are compared. If it is determined that the transmission power level P_{A} is equal to or greater than the transmission power level P_{B}, the process progresses to Step 110, where the downlink transmission power levels P_{B} and P_{C} of the sectors B and C, respectively, are compared. If it is determined that the transmission power level P_{B} is equal to or greater than the transmission power level P_{C}, the process progresses to Step 112. In this case, the relations among the power levels are PA>=PB>=PC. At Step 112, the beam width θ_{A} of the sector A is reduced by a predetermined amount X, the beam width θ_{B} of the sector B is kept unchanged, and the beam width θ_{C} of the sector C is expanded by the predetermined amount X. Consequently, the downlink transmission power of the sector A is reduced, the downlink power of the sector B is maintained, and the downlink transmission power of the sector C is increased.

On the other hand, if it is determined at Step 110 that the transmission power level P_{B} is not equal to or greater than the transmission power level P_{C}, the process progresses to Step 114, and the transmission power levels P_{C} and P_{A} are compared. If it is determined that the transmission power level P_{C} is equal to or greater than the transmission power level P_{A}, the process progresses to Step 116. The relations among the power levels, in this case, are P_{C}>=P_{A}>=P_{B}. At Step 116, the beam width θ_{C} of the sector C is reduced by the predetermined amount X, the beam width θ_{A} of the sector A is kept unchanged, and the beam width θ_{B} of the sector B is increased by the predetermined amount X. To the contrary, if it is determined that the transmission power level P_{C} is not equal to or greater than transmission power level P_{A} at Step 114, the process progresses to Step 118. The relations among the power levels in this case are P_{A}>P_{C}>P_{B}. At Step 118, the beam width θ_{A} of the sector A is reduced by the predetermined amount X, the beam width θ_{C} of the sector C is maintained, and the beam width θ_{B} of the sector B is increased by the predetermined amount X.

Similarly, when it is determined that the transmission power level P_{A} is not equal to or greater than the transmission power level P_{B} in Step 108, the transmission power levels P_{B} and P_{C} are compared at Step 120, and the transmission power levels P_{C} and P_{A} are compared at Step 122. If it is determined that P_{B}>=P_{C}>=P_{A}, the process progresses to Step 124, where the beam width θ_{B} of the sector B is reduced by the predetermined amount X, the beam width θ_{C} of the sector C is maintained, the beam width θ_{A} of the sector A is expanded by the predetermined amount X. If the relations are P_{B}>P_{A}>P_{C}, the process progresses to Step 126, where the beam width θ_{B} of the sector B is reduced by the predetermined amount X, the beam width θ_{A} of the sector A is maintained, and the beam width θ_{C} of the sector C is expanded by the predetermined amount X. In the case that the relations are PC>PB>PA, the process progresses to Step 128, where the beam width θ_{C} of the sector C is reduced by the predetermined amount X, the beam width θ_{B} of the sector B is maintained, and the beam width θ_{A} of the sector A is expanded by the predetermined amount X.

As described above, in the third embodiment, the beam widths of all the sectors are adjusted all at once, after determining the power level relations of the transmission power levels of all the sectors. In other words, if the relations are, for example, PA>=PB>=PC, the beam width adjustment process of only Step 112 is performed. This embodiment is desirable from a viewpoint that the even distribution of the downlink transmission power levels is established at an early stage through a small number of beam width adjustment operations, contributing to stabilized operations of the system.

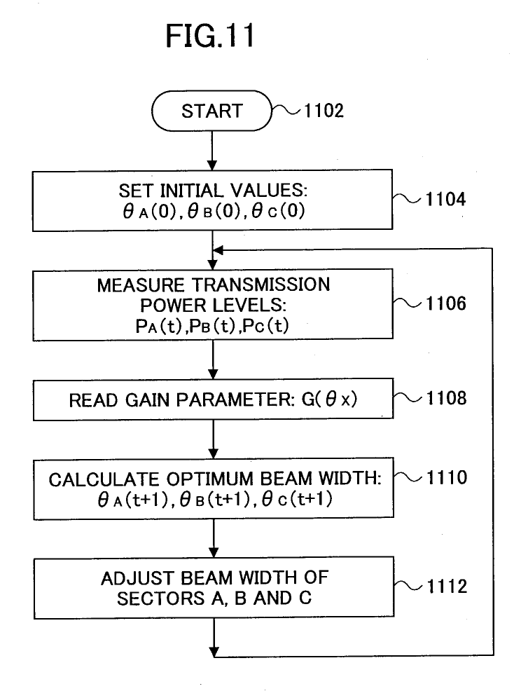

The fourth embodiment of the beam controlling method is explained with reference to a flowchart of FIG. 11. For explanation purposes, a 3-sector cell is described, consisting of the sectors A, B, and C. However, the number of the sectors in the cell may be greater than 3. The fourth embodiment computes beam width by numerical calculation, without comparing the downlink transmission power levels, which is performed in other embodiments of the present invention.

Processes of the fourth embodiment starts at Step 1102. Initial values of the beam width for each of the sectors are set up at θ_{A}(0), θ_{B}(0), and θ_{C}(0) at Step 1104. Although the initial values can be set up such that the beam widths of all sectors are equal to each other, other appropriate initial values can be set up where deviation of traffic, subscribers and the like can be predicted to some extent.

At Step 1106, current downlink transmission power levels P_{A}(t), P_{B}(t), and P_{C}(t) of the sectors A, B, and C, respectively, at a point in time (t) are measured. Here, the current downlink transmission power levels may be obtained by averaging two or more values that are measured, which may be preferred in a system where the downlink transmission power levels change rather frequently or widely.

At Step 1108, a gain parameter G(θx) required for the numerical calculation is acquired from a storage device such as a database (not shown) and the storage unit 536 (FIG. 5).

At Step 1110, the downlink transmission power level Po(t+1), and the beam width θ_{A}(t+1), θ_{B}(t+1), and θ_{C}(t+1), at a next point in time (t+1) are obtained by solving the following simultaneous equations.

$$\begin{matrix}{P}_{o} ( t + 1 ) = \frac{G ( {θ}_{A} ( t ) ) \cdot {P}_{A} ( t ) + G ( {θ}_{B} ( t ) ) \cdot {P}_{B} ( t ) + G ( {θ}_{C} ( t ) ) \cdot {P}_{C} ( t )}{G ( {θ}_{A} ( t + 1 ) ) + G ( {θ}_{B} ( t + 1 ) ) + G ( {θ}_{C} ( t + 1 ) )} \\ {θ}_{A} ( t + 1 ) = \frac{G ( {θ}_{A} ( t + 1 ) ) \cdot {θ}_{A} ( t ) \cdot {P}_{o} ( t + 1 )}{G ( {θ}_{A} ( t ) ) \cdot {P}_{A} ( t )} \\ {θ}_{B} ( t + 1 ) = \frac{G ( {θ}_{B} ( t + 1 ) ) \cdot {θ}_{B} ( t ) \cdot {P}_{o} ( t + 1 )}{G ( {θ}_{B} ( t ) ) \cdot {P}_{B} ( t )} \\ {θ}_{C} ( t + 1 ) = \frac{G ( {θ}_{C} ( t + 1 ) ) \cdot {θ}_{C} ( t ) \cdot {P}_{o} ( t + 1 )}{G ( {θ}_{C} ( t ) ) \cdot {P}_{C} ( t )}\end{matrix}$$

Here, the downlink transmission power level Po(t+1) is a level of the power transmitted to each sector at the point in time (t+1). That is, the level of the power transmitted to each of the sectors is the same Po(t+1).

At Step 1112, the directivity control unit 534 (FIG. 5) controls each of the antenna unit 508, 518, and 528 such that each beam width at the point in time (t+1) is set to the beam width θ_{A}(t+1) θ_{B}(t+1), and θ_{C}(t+1), respectively, which are obtained at previous Step 1110. Henceforth, the process returns to Step 1106, and measurement of the transmission power levels and adjustment of the beam width are repeated.

The gain parameter G(θx) is, in general, a function of the beam width θx (x=A, B, and C). When change of the beam width between a point in time (t), and a later point in time (t+1) is small, change of the gain G of an antenna is also small. Therefore, it is possible to approximate as G(θx(t))=G(θx(t+1))=1. In this case, the calculation at Step 1110 can use the following equation.

$$\begin{matrix}{P}_{o} ( t + 1 ) = \frac{{P}_{A} ( t ) + {P}_{B} ( t ) + {P}_{C} ( t )}{3} \\ {θ}_{A} ( t + 1 ) = \frac{{P}_{A} ( t ) + {P}_{B} ( t ) + {P}_{C} ( t )}{3 \cdot {P}_{A} ( t )} \cdot {θ}_{A} ( t ) \\ {θ}_{B} ( t + 1 ) = \frac{{P}_{A} ( t ) + {P}_{B} ( t ) + {P}_{C} ( t )}{3 \cdot {P}_{B} ( t )} \cdot {θ}_{B} ( t ) \\ {θ}_{C} ( t + 1 ) = \frac{{P}_{A} ( t ) + {P}_{B} ( t ) + {P}_{C} ( t )}{3 \cdot {P}_{C} ( t )} \cdot {θ}_{C} ( t )\end{matrix}$$

Moreover, G(θx) can be considered to be proportional to 1/θx, paying attention to the property of the antenna, that is, the gain becomes greater as the beam width of an antenna becomes narrower. In this case, the calculation at Step 1110 can use the following equation.

$$\begin{matrix}{θ}_{A} ( t + 1 ) = {( \frac{{P}_{o} ( t + 1 )}{P ( t )} )}^{1 / 2} \cdot {θ}_{A} ( t ) \\ {θ}_{B} ( t + 1 ) = {( \frac{{P}_{o} ( t + 1 )}{P ( t )} )}^{1 / 2} \cdot {θ}_{B} ( t ) \\ {θ}_{C} ( t + 1 ) = {( \frac{{P}_{o} ( t + 1 )}{P ( t )} )}^{1 / 2} \cdot {θ}_{C} ( t ) \\ {( {P}_{o} ( t + 1 ) )}^{1 / 2} = \frac{{θ}_{B} ( t ) \cdot {θ}_{C} ( t ) \cdot {P}_{A} ( t ) + {θ}_{C} ( t ) \cdot {θ}_{A} ( t ) \cdot {P}_{B} ( t ) + {θ}_{A} ( t ) \cdot {θ}_{B} ( t ) \cdot {P}_{C} ( t )}{\begin{matrix}{θ}_{B} ( t ) \cdot {θ}_{C} ( t ) \cdot {{P}_{A} ( t )}^{1 / 2} + {θ}_{C} ( t ) \cdot {θ}_{A} ( t ) \cdot {{P}_{B} ( t )}^{1 / 2} + \\ {θ}_{A} ( t ) \cdot {θ}_{B} ( t ) \cdot {{P}_{C} ( t )}^{1 / 2}\end{matrix}}\end{matrix}$$

In this embodiment, the beam width (therefore, an optimal transmission power value) is obtained by the numerical calculation, without comparing the transmission power levels. This method has an advantage that the speed of response to environmental change of the system is high. Further, this embodiment is able to obtain a suitable solution for equalizing the downlink transmission power levels directly, free from the time delay of the convergence relative to the comparison of the power levels with the adjoining sectors.

As explained above, according to the embodiments of the present invention, the beam width of the directional antenna is controlled such that the downlink transmission power levels of the sectors become equal to each other. A large transmission power corresponds to a large beam width of the directional antenna. A small transmission power corresponds to a small beam width of the directional antenna. Even if a communication environment, such as the downlink traffic, is uneven, the sector configuration can be flexibly adjusted based on the transmission power levels, raising the accommodation capacity of the cell.

Applications of the embodiments of the present invention are highly effective in a code division multiple access cellular communications system, which performs software hand-off between sectors, permitting a mobile terminal to belong to a plurality of the sectors.

According to the embodiments of the preset invention, the sector configuration is adjusted based on the downlink transmission power levels, unlike the conventional technology of adjusting the sector configuration based on the number of mobile terminals, SIR (signal to interference ratio), or an error rate. With the conventional technology, even if the sectors are reconfigured based on the number of the mobile terminals, if one or any of the mobile terminals are located far from the base station, or communication speeds required by the mobile stations are uneven, the accommodation capacity of the cell is not necessarily expanded. Conversely, if the present invention is employed, and the sectors are reconfigured based on the downlink transmission power, the antenna beam width is reduced for a sector that contains mobile terminals in a distance or requiring a high-speed service, while expanding the antenna beam width for other sectors, thereby the accommodation capacity of the cell is increased.

As for the conventional technology that uses SIR and the error rate, the base station can easily obtain SIR and the error rate of the uplink. However, it is generally difficult for the base station to obtain SIR and the error rate of the downlink, which are available on the mobile terminal side, and further to control SIR and the error rate of the downlink. Further, as soft handover technology is being widely used in the code division multiple access system, a mobile terminal can belong to two or more sectors, in which case, the number of the mobile terminals in a sector does not mean much for the purposes of the sector reconfiguration.

All above having been said, if the mobile terminals are evenly distributed in a cell, and if all the mobile terminals require almost the same transmission speed (for example, all the mobile terminals are distributed evenly in the cell and conducting voice communications), the conventional method based on the number of mobile terminals, etc. and the method of the present invention based on the downlink transmission power level may each deliver a sector configuration that is similar to the other. It is because the downlink transmission power level and the number of the mobile terminals correspond relatively clearly in this case. However, as mentioned above, unevenness, due to the geographical distribution of the mobile terminals in the sectors being uneven, versatile transmission speeds being required, different service levels being required, and the like, are tending to become greater as time goes by, as the services are diversified and the number of the subscribers is increasing. Consequently, it is advantageous to adjust the sector configuration based on the downlink transmission power level in order to raise the accommodation capacity of the cell, whether the communication environment is uniform or uneven.

Furthermore, even if a system is optimized to accommodate as many mobile terminals as possible by reconfiguring the sectors based on the number of mobile terminals in a sector etc., a sector transmitting at a greater power than others will give a large amount of interference to other sectors or cells. In order to cope with the interference, other sectors will need more power, generating a vicious cycle of increasing noise level of the system. Since the present invention attempts to equalize the downlink transmission power levels among the sectors, the number of mobile terminals that can be accommodated is maximized, while suppressing unnecessary noise.

As mentioned above, according to the present invention, an uneven distribution of the downlink traffic can be coped with flexibly, and the accommodation capacity of the cell is increased, by controlling the beam width of the directional antennas such that the downlink transmission power levels of the sectors are made equal.

Further, the present invention is not limited to these embodiments, but various variations and modifications may be made without departing from the scope of the present invention.

The present application is based on Japanese priority application No. 2002-232590 filed on Aug. 9, 2002 with the Japanese Patent Office, the entire contents of which are hereby incorporated by reference.

What is claimed is:

1. An antenna control unit used in a cellular communications system that employs a sectorized cell that consists of a plurality of sectors, wherein the beam width of a directional antenna provided to each of the sectors is controlled such that the downlink transmitted power levels of at least two of the sectors are made equal to each other.

2. The antenna control unit as claimed in claim 1, wherein the cellular communications system is a code division multiplex access (CDMA) communications system.

3. The antenna control unit as claimed in claim 1, wherein the two sectors are adjacent to each other, and the beam width of the directional antenna of each of the two sectors is adjusted according to relative magnitude of the two downlink transmitted power levels.

4. The antenna control unit as claimed in claim 1, wherein the beam width of each of the directional antennas, which beam width provides the same downlink transmission power level to each of the sectors, is obtained by solving a predetermined set of simultaneous equations about the beam widths of the directional antennas and the downlink transmission power levels of the sectors.

5. The antenna control unit as claimed in claim 1, wherein the cell consists of three sectors, with a first sector transmitting at a downlink power level greater than any other sector, a second sector transmitting at a downlink power level smaller than any other sector, and a third sector transmitting at a downlink power level between the downlink power level of the first sector and the downlink power level of the second sector.

6. An antenna control unit that sequentially compares the downlink transmission power level of a sector of a plurality of sectors with the downlink transmission power level of another sector of the plurality of the sectors, expands the beam width of a directional antenna of the compared sector that is determined to have the larger downlink power level, and reduces the beam width of the directional antenna of the compared sector that is determined to have the smaller downlink power level.

7. The antenna control unit as claimed in claim 6, comprising storage means for recording information about how many times the beam width of the directional antenna is expanded, and information about how many times the beam width of the directional antenna is reduced, for each of the plurality of sectors.

8. The antenna control unit as claimed in claim 6, wherein the amount by which the beam width of the directional antenna is expanded or reduced is determined based on the difference between the downlink transmitted power levels of two adjoining sectors.

9. An antenna control unit, wherein the beam width of a directional antenna of a first sector, said first sector having a second sector that is adjacent to the first sector on one side, is expanded or reduced based on the relative magnitude of the downlink transmission power levels of the first sector and the second sector, and the beam width of the directional antenna of the first sector, said first sector having a third sector that is adjacent to the first sector on another side, is expanded or reduced based on the relative magnitude of the downlink transmission power levels of the first sector and the third sector.

10. An antenna control unit that controls one of a plurality of directional antennas provided corresponding to one of a plurality of sectors, comprising:
supervisory means for supervising the downlink transmitted power level of each directional antenna; and
control means for controlling the beam width of the directional antenna of each sector based on supervision by the supervisory means.
